(19) United States
(12) Patent Application Publication
(10) Pub. No.: US 2020/0131842 A1
(43) Pub. Date: Apr. 30, 2020

(54) TWO-PIECE DOOR AND INSTALLATION SYSTEM

(71) Applicant: Larson Manufacturing Company of South Dakota, Inc., Brookings, SD (US)

(72) Inventors: Bruce Thomas, Brookings, SD (US); Thomas Gernetzke, Beverly, MA (US); Marcus Hanna, Charlestown, MA (US); Ryan Thompson, Maynard, MA (US); Michael Tinstman, Malden, MA (US)

(21) Appl. No.: 16/664,076

(22) Filed: Oct. 25, 2019

Related U.S. Application Data
(60) Provisional application No. 62/750,293, filed on Oct. 25, 2018.

(51) Int. Cl. E06B 3/70; E06B 5/00; E06B 5/11; E06B 9/52; E05C 7/00

(52) U.S. Cl. CPC E06B 3/7009; E06B 5/003; E05C 7/005; E06B 9/52; E06B 5/11

(57) ABSTRACT

A two-piece door kit comprises frame members comprising two or more components that can be connected with one or more connectors, a bottom panel that can be movably attached to the frame members, a top panel that can be movably attached to the frame members. Prior to assembly, the two-piece door kit may be packaged compactly in a carton in which the total of the carton length plus twice the carton width plus twice the carton thickness is less than or equal to 165 inches.

### CROSS-REFERENCE TO RELATED APPLICATION

This application claims priority to U.S. Provisional Patent Application No. 62/750,293, filed Oct. 25, 2018, entitled “TWO PIECE DOOR AND INSTALLATION SYSTEM,” of which is incorporated by reference herein, in the entirety and for all purposes.

### FIELD OF THE DISCLOSURE

The present disclosure concerns two-piece door kits, where the door may be a primary door, a storm door, a screen door, or a security door, which comprises frame members comprising two or more components that can be connected with one or more connectors, top and bottom panels that can be movably attached to the frame members.

### BACKGROUND

Door systems for entrances into residential and commercial buildings are well known in the art. Primary doors provide the main security and protection from exterior elements, while secondary doors such as screen doors, storm doors, and security doors offer additional functionality such as enhanced ventilation, energy efficiency, and security when paired with an existing primary door.

Despite their widespread use, existing door systems have limitations. For instance, even single-panel doors for a typical 32″ or 36″ wide by 80″ tall residential opening can be cumbersome to handle and transport. They are often larger than can be easily carried in a car, resulting in the need to borrow or rent a larger vehicle (inconvenient), arrange for delivery (costly), or not purchasing and installing the door at all (undesirable for both the purchaser and seller). As shopping and purchasing trends shift to a higher percentage of products being selected and purchased over the internet instead of through brick-and-mortar retail locations, shipping of large door systems that are outside of mainstream shipping carriers' size limits can be cost-prohibitive. Existing door systems often require specialized knowledge or skills to install properly, which may also result in the installation of a door to be done poorly or not at all. And furthermore, today's doors may lack the functionality or selection that appeals to a wide variety of consumers and decision-makers.

The present disclosure seeks to address these issues, and may be utilized for primary and secondary residential and commercial door systems.

### SUMMARY

This disclosure describes a two-piece door kit comprising a latch frame member comprising two or more components that can be connected with one or more connectors, a hinge frame member comprising two or more components that can be connected with one or more connectors, a top frame member that can be connected to the top of the latch frame member and the hinge frame member, a bottom frame member that can be connected to the bottom of the is latch frame member and the hinge frame member, a bottom panel that can be movably attached to the bottom frame member and the hinged frame member or elements thereof, a top panel that can be movably attached to the hinge frame member and the top frame member or elements thereof, and an optional awning that can be attached to the top frame member.

In some embodiments, the two-piece door kit further comprises a latch to secure the bottom panel, or the top panel or both panels to the latch frame member.

In other embodiments, the bottom and top panels move together or independently.

In some embodiments, the two-piece door kit further comprises an adjustable connector to secure the bottom and top panels together.

In other embodiments, the bottom and top panels are opaque materials, transparent materials, translucent materials, or screen materials.

In some embodiments, the bottom and top materials are the same or different materials.

In other embodiments, the bottom and top panels move about two or more pins.

In some embodiments, at least one pin is spring-biased to an extended position.

In other embodiments, the awning is further comprises one or more accessories including a door light, security camera, alarm system, intercom, automatic door opening and closing mechanism, or a solar cell and battery to collect, store, and provide power to the accessories.

In some embodiments, the two or more latch frame members and hinge frame members snap together with the connectors.

In other embodiments, the two-piece door is a primary door, a storm door, a screen door, or a security door.

In some embodiments, an assembled two-piece door may be attached to the exterior face of a door frame, or alternatively may be attached within the exterior opening of a door frame.

In other embodiments, a packaged two-piece door kit may be contained in a carton in which the total of the carton length plus twice the carton width plus twice the carton thickness is less than or equal to 165 inches. For example, a packaged two-piece door kit may be contained in a carton approximately 36 inches×36 inches×8 inches.

All scientific and technical terms used herein have meanings commonly used in the art unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### BRIEF DESCRIPTION OF THE FIGURES

FIG. 1 is an exterior-side front view of a two-piece door system as assembled, with both panels of the door in the closed position.

FIG. 2 is an exterior-side angle view of a two-piece door system as assembled, with both panels of the door in the closed position.

FIG. 3 is an exterior-side angle view of a two-piece door system as assembled, with both panels of the door in the open position.

FIG. 4 is an exterior-side angle view of a two-piece door system as assembled, with the top panel of the door in the open position and the bottom panel of the door in the closed position.

FIG. 5 is an exterior-side exploded view of a two-piece door system.

FIG. 6 is an exterior-side exploded view of the top latch-side frame connector and associated parts.

FIG. 7 is an exterior-side exploded view of the bottom latch-side frame connector and associated parts.

FIG. 8 is an exterior-side exploded view of the top hinge-side frame connector and associated parts.

FIG. 9 is an exterior-side exploded view of the bottom hinge-side frame connector and associated parts.

FIG. 10 is an exterior-side exploded view of the middle latch-side frame connector and associated parts.

FIG. 11 is an exterior-side exploded view of the middle hinge-side frame connector and associated parts.

FIG. 12 is an exterior-side exploded view illustrating the connection of door panel hinges to the middle hinge-side frame connector.

FIG. 13 is an exterior-side cutaway view of the lower panel latch assembly.

FIG. 14 is an interior-side cutaway view of the lower panel latch assembly, also depicting the upper panel release assembly.

FIG. 15 is an exterior-side cutaway view of the lower panel latch assembly and upper panel release assembly.

FIG. 16 is the exterior of a carton designed to contain a two-piece door system.

FIG. 17 is the interior of a carton designed to contain a two-piece door system.

FIG. 18 is the interior of a carton designed to contain a two-piece door system with parts tray removed revealing an upper door panel.

The following index describes the reference numbers used throughout the figures:
10 assembled two-piece door system
20 upper door panel
30 lower door panel
40 top frame member
50 upper latch-side frame member
60 upper hinge-side frame member
70 lower latch-side frame member
80 lower hinge-side frame member
90 middle latch-side frame connector
100 middle hinge-side frame connector
110 top latch-side frame connector
111 arm of top latch-side frame connector
112 arm of top latch-side frame connector
120 top hinge-side frame connector
121 arm of top hinge-side frame connector
122 arm of top hinge-side frame connector
130 bottom frame member
140 bottom transition plate
150 bottom latch-side frame connector
151 arm of bottom latch-side frame connector
152 arm of bottom latch-side frame connector
160 bottom hinge-side frame connector
161 arm of bottom hinge-side frame connector
162 arm of bottom hinge-side frame connector
170 top hinge pin
180 top hinge pin receiver assembly
190 top spring hinge pin assembly
191 top spring hinge pin
192 top spring hinge pin assembly cover
200 top spring hinge pin receiver
210 bottom hinge pin
220 bottom hinge pin receiver assembly
221 bottom hinge pin receiver
222 bottom hinge pin receiver assembly cover
230 bottom spring hinge pin assembly
231 bottom spring hinge pin
240 bottom spring hinge pin receiver
250 lower panel latch assembly
260 upper panel release assembly
261 release assembly handle
270 exterior handle
280 interior handle
290 top latch-side cover
300 top hinge-side cover
310 middle latch-side cover
320 middle hinge-side cover
330 bottom latch-side cover
340 bottom hinge-side cover
350 frame support
360 transition plate extender
370 mounting screw
375 mounting screw hole
380 carton
390 parts tray

### DESCRIPTION

A door system according to the present disclosure may be comprised of a latch frame member, a hinge frame member generally parallel to the latch frame member, a top frame member, a bottom frame member generally parallel to the top frame member, a lower panel pivotable with respect to the frame members, an upper panel pivotable with respect to the frame members, a panel connecting mechanism that permits the upper and lower panels to pivot together or independently of each other, latching hardware that enables the panels to selectively latch to or disengage from the latch frame member, and a top valence.

The latch frame member may be comprised of an upper section and a lower section, joined together by an intermediate latch frame connector. The upper and lower sections may be formed of aluminum, steel, extruded or molded plastic, fiberglass, or other suitable material. The intermediate latch frame connector may be formed of metal or plastic, and may be molded, die cast, machined, or formed using some other process. In addition to containing features to receive the upper and lower latch frame members, the intermediate latch frame connector may also contain a latch strike, deadbolt strike, or both. The latch frame member may also carry upper and lower corner connectors. The connectors may also be assemblies of multiple parts.

The hinge frame member may be comprised with an upper section and a lower section, joined together by an intermediate hinge frame connector. The upper and lower sections may be formed of aluminum, steel, extruded or molded plastic, fiberglass, or other suitable material. The intermediate hinge frame connector may be formed of metal or plastic, and may be molded, die cast, machined, or formed using some other process. In addition to containing features to receive the upper and lower hinge frame members, the intermediate hinge frame connector may also contain a protrusion carrying a hole capable of receiving a hinge post. The hinge frame member may also carry upper and lower corner connectors. Corners of the upper and lower panels may have hinge pins or receivers. Alternately hinge-side corner connectors may carry holes to receive a hinge pin or a hinge pin capable of sliding into a hinge pin receiver. Intermediate hinge frame connector may also carry a hinge pin capable of sliding into a hinge pin receiver, or both.

The top frame member may be a unitary member, and may be formed of aluminum, steel, extruded or molded plastic, fiberglass, or other suitable material. The ends of the top frame member are adapted to slide onto the upper corner connectors carried by the latch frame and hinge frame members, forming a 90-degree corner at each upper corner. The underside of each end of the top frame member may include a hole sized and shaped to receive a bushing, in turn sized and shaped to receive a hinge pin.

The bottom frame member may be a unitary member, and may be formed of aluminum, steel, extruded or molded plastic, fiberglass, or other suitable material. The ends of the bottom frame member are adapted to slide onto the lower corner connectors carried by the latch frame and hinge frame members, forming a rigid 90-degree corner at each lower corner. Each end of the bottom frame member may include a hole sized and shaped to receive a bushing, in turn sized and shaped to receive a hinge pin. Top and bottom frame members may carry the corner connectors instead of the latch and hinge frame members. In some embodiments the top and bottom frame members may not have the holes to receive a hinge pin.

The assembled frame may be positioned over an existing door frame and door panel when it is to be used as a secondary door to enhance an existing primary door. The frame is attached to the existing door frame or building structure surrounding the existing doorway, utilizing screws, nails, adhesive, or other suitable attachment devices. In one embodiment, screws are prepositioned in the frame members and ready to be driven into the existing door frame or building structure, in a direction perpendicular to the plane of the wall. Alternately, when the door assembly is to be used as a primary door, the assembled frame may be positioned within the rough opening. In this embodiment, screws prepositioned in the frame members would be driven into the studs forming the rough opening, in a direction parallel to the plane of the wall. In some embodiments screws may be prepositioned in the connectors instead of the frame members.

A lower panel may be comprised of a top horizontal rail, bottom horizontal rail, and left and right vertical stiles surrounding a glass insert. A lower corner of the lower panel carries a hinge pin (not visible), sized and shaped to engage with the bushing in one of the ends of the bottom frame member. An upper corner of the lower panel is notched to mate with the protrusion extending from the intermediate hinge frame connector, and may include a hole sized and shaped to receive a bushing, in turn sized and shaped to receive a hinge post.

The hinge pin of in the lower corner of the lower panel is inserted into the bushing in one of the ends of the bottom frame member, the sash is positioned such that the bushing in the upper corner of the lower sash is aligned axially with the hole in the protrusion extending from the intermediate hinge frame connector, and a hinge post is inserted through the hole in the protrusion and into the bushing in the upper corner of the lower sash.

An upper panel may be comprised of a top horizontal rail, bottom horizontal rail, and left and right vertical stiles surrounding a glass insert. A lower corner of the upper panel is notched to mate with the protrusion extending from the intermediate hinge frame connector, and may include a hole sized and shaped to receive a bushing, in turn sized and shaped to receive the hinge post. An upper corner of the upper panel carries a hinge pin, which may be a spring-loaded or spring-biased retractable hinge pin, sized and shaped to engage with the bushing in one of the ends of the top frame member. Upper and lower panels may not be comprised of 2 rails and 2 stiles, but may be a unitary (such as injection-molded around the panel material).

The bushing in the lower corner of the upper panel may be positioned over the hinge post, the sash is positioned such that the hinge pin in the upper corner of the upper sash is aligned axially with the bushing in one of the ends of the top frame member, and the hinge pin in the upper corner of the upper sash is engaged with the bushing in one of the ends of the top frame member.

An exterior handle and an interior handle are each attached to the latching hardware.

A valence mounts to the upper corner connectors of the latch and hinge frame members. Mounting methods may include receptacles designed to receive the upper corner connectors, screws, adhesive, or any other suitable fastening device. Such a valence may be adapted to receive one or more accessories, including but not limited to a door light, security camera, alarm system, intercom, automatic door opening and closing mechanism, and solar cell and battery to collect, store, and provide power to other accessories.

A panel connecting mechanism permits the upper and lower panels to pivot together or independently of each other. In one embodiment, this may be a bolt affixed to one panel that may be thrown to engage a strike on the other panel, thereby causing the panels to pivot together with respect to the frame members or pivot independently of each other. In another embodiment, connection of the panels may be accomplished through the latching hardware. Rotation of one of the handles in an upward direction, for example, may enable the upper panel to pivot independently of the lower panel while the lower panel remains latched to the latch frame member, while rotation of one of the handles in a downward direction, for example, may connect the panels together, enabling the upper and lower panels to pivot at the same time.

The modular design of the product along with the package design produces a product that can be easily transported in nearly any typical vehicle or shipped easily and inexpensively following a purchase over the internet. In one embodiment, the packaged product is approximately 36″×36″×6″ and includes a carrying handle. Within the package, presentation of the individual components is in the sequence in which the parts are used during installation, and designed in such a manner that all parts are well protected from damage and abuse.

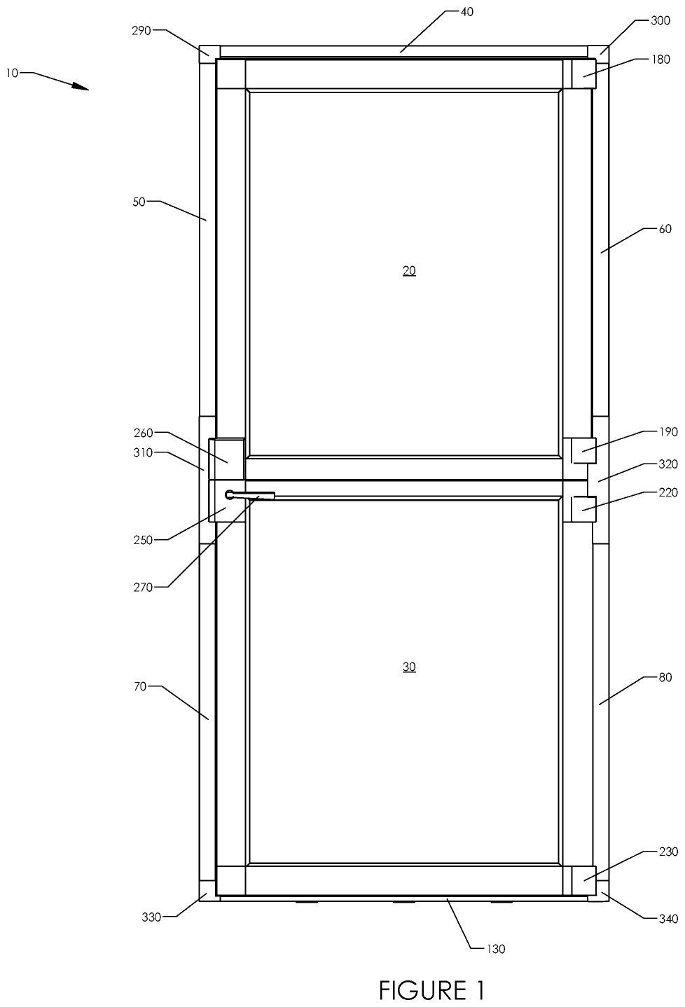

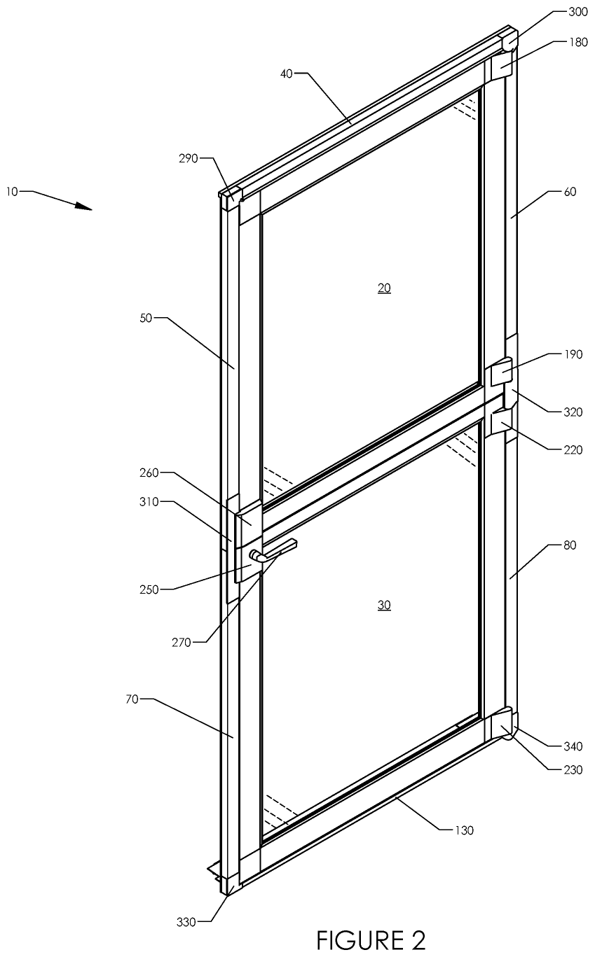

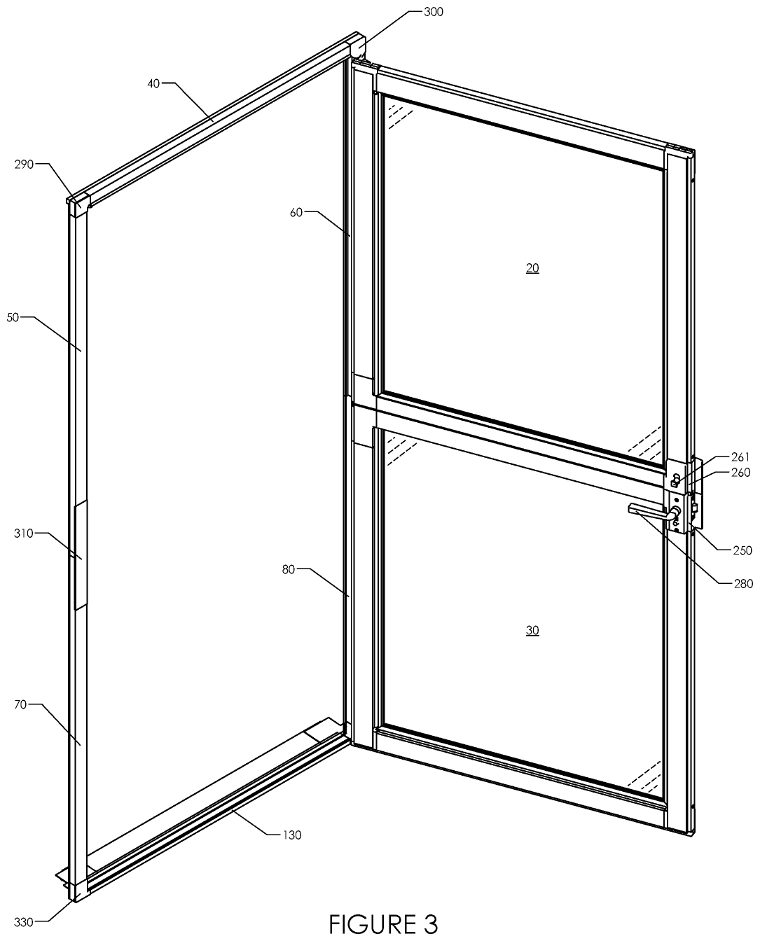

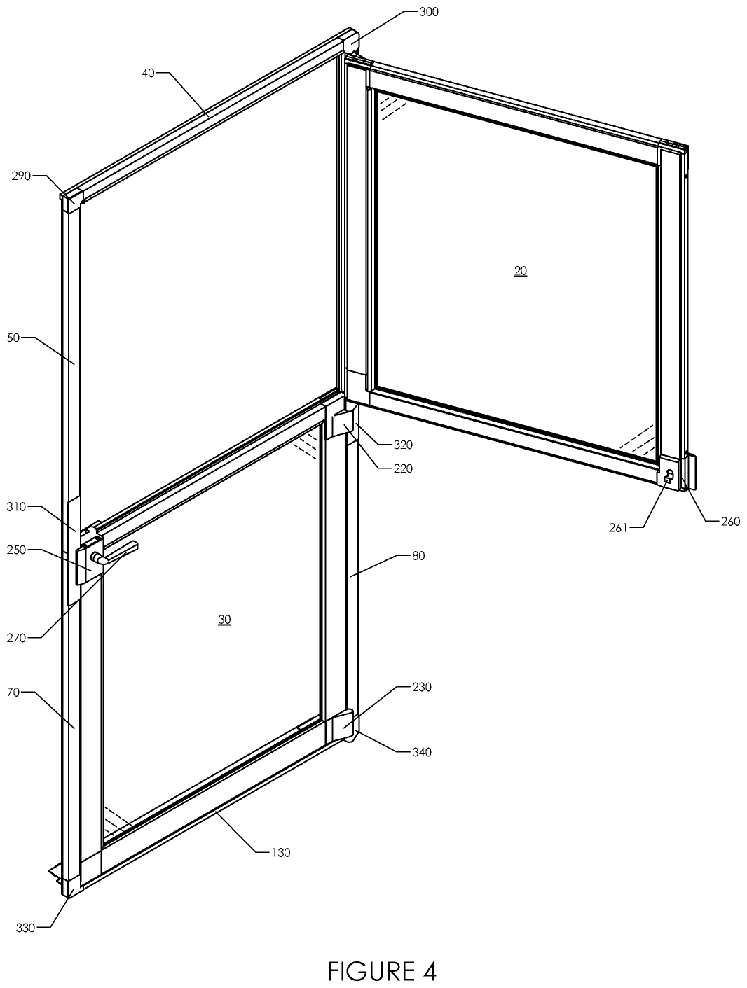

As shown in FIGS. 1-4, assembled two-piece door system 10 is comprised of a door comprising two pieces, upper door panel 20 and lower door panel 30. Upper door panel 20 comprises upper panel release assembly 260, which can be engaged by operation of release assembly handle 261 to mechanically couple upper door panel 20 with lower door panel 30 such that they move in tandem, or can be disengaged such that upper door panel 20 can be opened independently of lower door panel 30. Lower door panel 30 comprises lower panel latch assembly 250 which may be operated by exterior handle 270 or interior handle 280. Lower panel latch assembly 250 engages with a door frame comprising top frame member 40, upper latch-side frame member 50, upper hinge-side frame member 60, lower latch-side frame member 70, lower hinge-side frame member 80, and bottom frame member 130. For improved aesthetics, additional components are concealed behind top latch-side cover 290, top hinge-side cover 300, middle latch-side cover 310, middle hinge-side cover 320, bottom latch-side cover 330, and bottom hinge-side cover 340. Upper door panel 20 comprises top hinge pin receiver assembly 180 and top spring hinge pin assembly 190, by which upper door panel 20 is rotatably attached to the door frame. Lower door panel 30 comprises bottom hinge pin receiver assembly 220 and bottom spring hinge pin assembly 230, by which lower door panel 30 is rotatably attached to the door frame. Typically, top hinge pin receiver assembly 180, top spring hinge pin assembly 190, and upper panel release assembly 260 are preinstalled in upper door panel 20. Typically, bottom hinge pin receiver assembly 220, bottom spring hinge pin assembly 230, and lower panel latch assembly 250 are preinstalled in lower door panel 30.

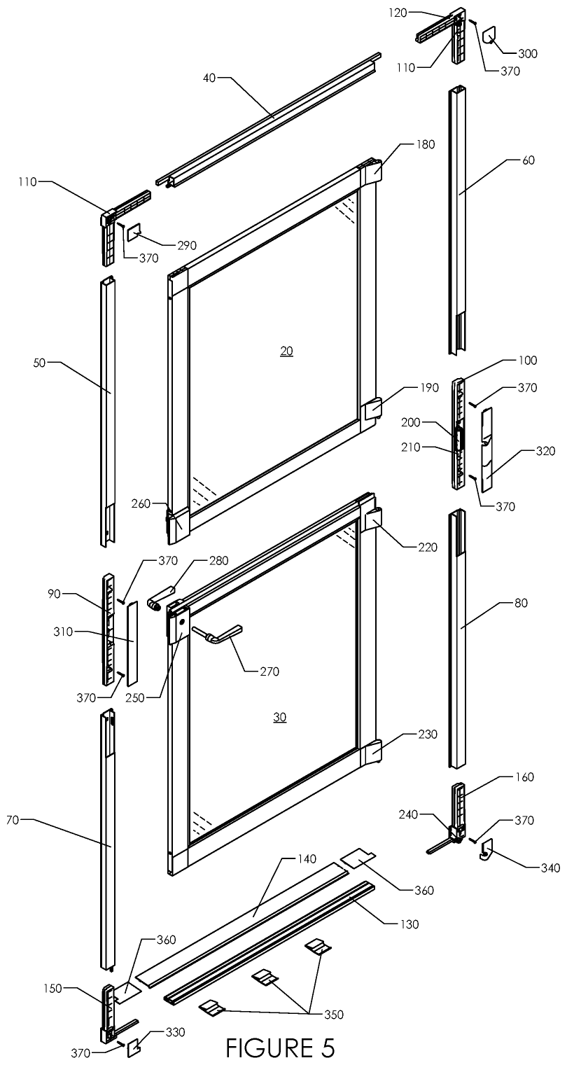

FIG. 5 is an exterior-side exploded view of a two-piece door system disclosing further components in addition to those described above. Top frame member 40, upper latch-side frame member 50, upper hinge-side frame member 60, lower latch-side frame member 70, lower hinge-side frame member 80, and bottom frame member 130 are joined to make a complete door frame by middle latch-side frame connector 90, middle hinge-side frame connector 100, top latch-side frame connector 110, top hinge-side frame connector 120, bottom latch-side frame connector 150, and bottom hinge-side frame connector 160. Eight mounting screws 370 may be used to mount the frame connectors, and thereby the entire door system, to an existing structure. In some embodiments, mounting screws 370 may be prepositioned in the various frame connectors. Frame supports 350 may be used to support bottom frame member 130. Bottom transition plate 140 may provide a smooth transition between bottom frame member 130 and the surface to the interior of the door system. The length of bottom transition plate 140 may be adjusted by sliding transition plate extenders 360 into each end of bottom transition plate 140 to the appropriate length. Alternately, the two-piece door system may employ the adjustable sill described in U.S. patent application Ser. No. 16/555,172 filed Aug. 29, 2019, and U.S. Patent Application 62/898,902 filed Sep. 11, 2019, the full contents of both applications being incorporated by reference in this disclosure. Top hinge-side frame connector 120 includes top hinge pin 170 which slides into a top hinge pin receiver (not visible) in top hinge pin receiver assembly 180 to form a rotatable hinge. Middle hinge-side frame connector 100 includes top spring hinge pin receiver 200 into which slides a top spring hinge pin 191 in top spring hinge pin assembly 190 to form a rotatable hinge. The top spring hinge pin 191 is spring loaded such that it may be pushed into top spring hinge pin assembly 190 and will return under the force of the spring to an extended position after it has been positioned over top spring hinge pin receiver 200. Middle hinge-side frame connector 100 includes bottom hinge pin 210 which slides into a bottom hinge pin receiver (not visible) in bottom hinge pin receiver assembly 220 to form a rotatable hinge. Bottom hinge-side frame connector 160 includes bottom spring hinge pin receiver 240 into which slides a bottom spring hinge pin 231 in bottom spring hinge pin assembly 230 to form a rotatable hinge. The bottom spring hinge pin 231 is spring loaded such that it may be pushed into bottom spring hinge pin assembly 230 and will return under the force of the spring to an extended position after it has been positioned over bottom spring hinge pin receiver 240.

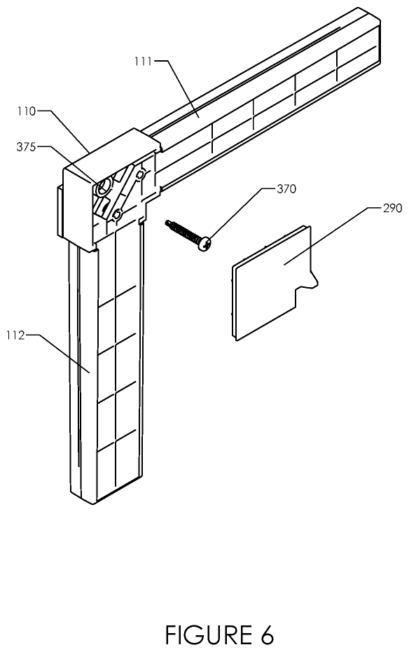

As shown in FIG. 6, top latch-side frame connector 110 comprises arms 111, 112, which slide into top frame member 40 and upper latch-side frame member 50 in the assembly of a completed door frame. Mounting screw 370 is driven through mounting screw hole 375 when mounting the completed door frame to an existing structure. For improved aesthetics, top latch-side cover 290 conceals the mounting screw after installation.

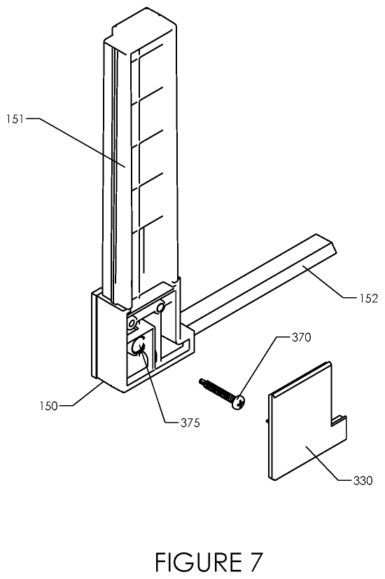

As shown in FIG. 7, bottom latch-side frame connector 150 comprises arms 151, 152, which slide into bottom frame member 130 and lower latch-side frame member 70 in the assembly of a completed door frame. Mounting screw 370 is driven through mounting screw hole 375 when mounting the completed door frame to an existing structure. For improved aesthetics, top latch-side cover 330 conceals the mounting screw after installation.

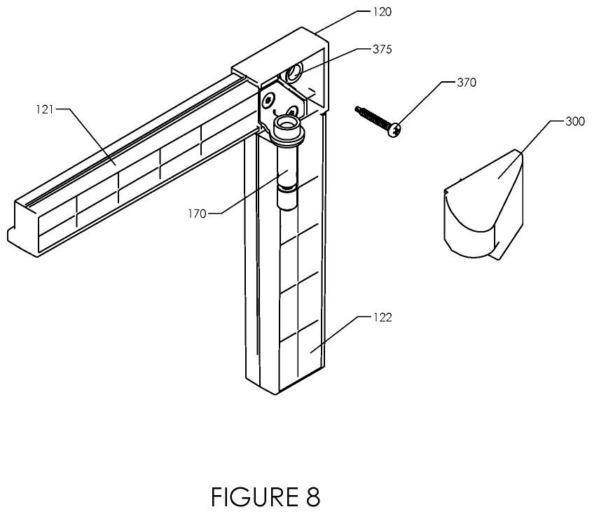

As shown in FIG. 8, top hinge-side frame connector 120 comprises arms 121, 122, which slide into top frame member 40 and upper hinge-side frame member 60 in the assembly of a completed door frame. Mounting screw 370 is driven through mounting screw hole 375 when mounting the completed door frame to an existing structure. Top hinge pin 170 forms a part of a hinge bearing upper panel 20, as described above in relation to FIG. 5. For improved aesthetics, top latch-side cover 300 conceals the mounting screw and hinge after installation.

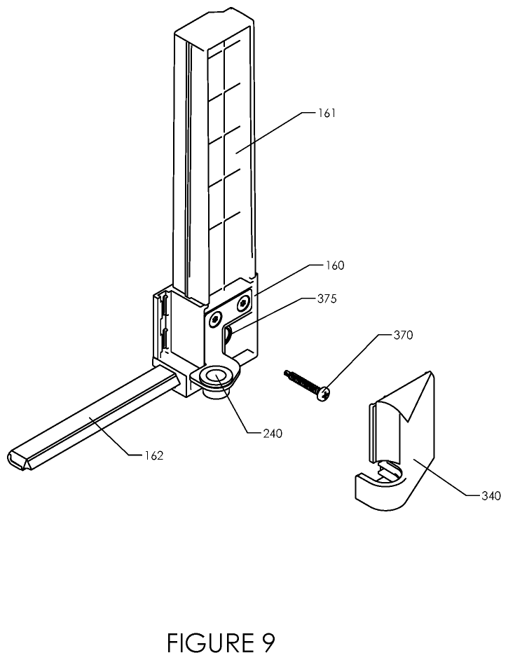

As shown in FIG. 9, bottom hinge-side frame connector 160 comprises arms 161, 162, which slide into bottom frame member 130 and bottom hinge-side frame member 80 in the assembly of a completed door frame. Mounting screw 370 is driven through mounting screw hole 375 when mounting the completed door frame to an existing structure. Bottom spring hinge pin receiver 240 forms a part of a hinge bearing lower panel 30, as described above in relation to FIG. 5. For improved aesthetics, top latch-side cover 340 conceals the mounting screw and hinge after installation.

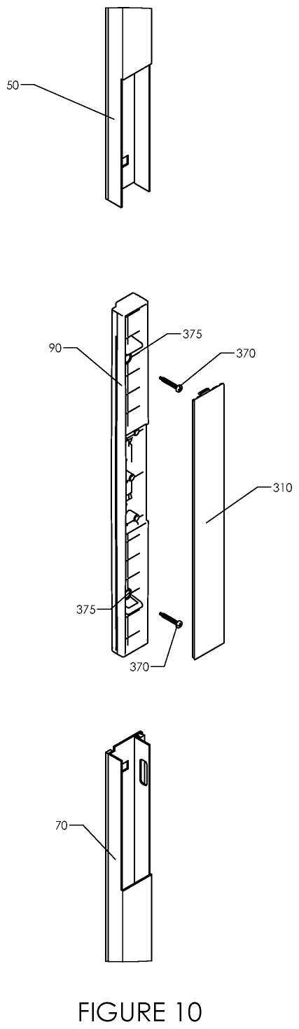

As shown in FIG. 10, middle latch-side frame connector 90 is adapted to slide into upper latch-side frame member 50 and lower latch-side frame member 70 in the assembly of a completed door frame. Mounting screws 370 are driven through mounting screw holes 375 when mounting the completed door frame to an existing structure. Apparatus for engaging the lower panel latch, such as a strike plate (not shown), may be installed on or be formed in middle latch-side frame connector 90. For improved aesthetics, middle latch-side cover 310 conceals the mounting screws after installation.

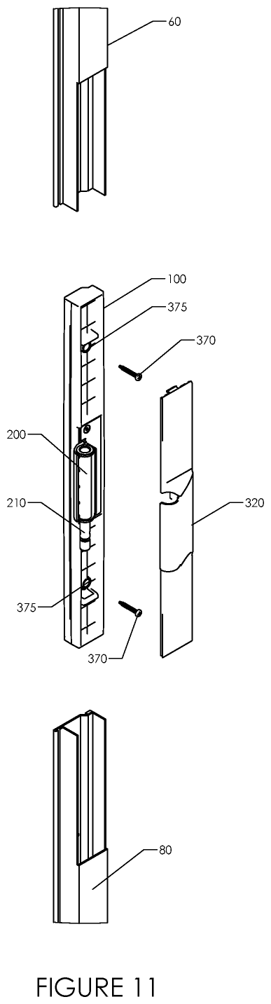

As shown in FIG. 11, middle hinge-side frame connector 100 is adapted to slide into upper hinge-side frame member 60 and lower hinge-side frame member 80 in the assembly of a completed door frame. Mounting screws 370 are driven through mounting screw holes 375 when mounting the completed door frame to an existing structure. Top spring hinge pin receiver 200 forms a part of a hinge bearing upper panel 20, as described above in relation to FIG. 5. Bottom hinge pin 210 forms a part of a hinge bearing lower panel 30, as described above in relation to FIG. 5. For improved aesthetics, middle hinge-side cover 320 conceals the mounting screws and hinge after installation.

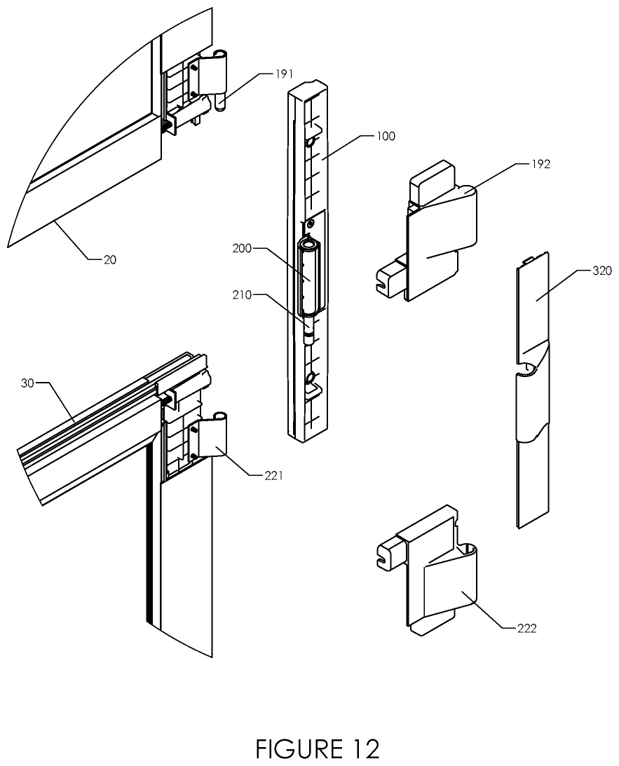

As shown in FIG. 12, top spring hinge pin assembly 190, mounted on upper panel 20, comprises top spring hinge pin 191 and top spring hinge pin assembly cover 192. Middle hinge-side frame connector 100 includes top spring hinge pin receiver 200 into which slides top spring hinge pin 191 to form a rotatable hinge. Top spring hinge pin 191 is spring loaded such that it may be pushed upward and will return under the force of the spring to an extended position after it has been positioned over top spring hinge pin receiver 200. Bottom hinge pin receiver assembly 220, mounted on lower panel 30, comprises bottom hinge pin receiver 221 and bottom hinge pin receiver assembly cover 222. Middle hinge-side frame connector 100 includes bottom hinge pin 210 which slides into a bottom hinge pin receiver 221 to form a rotatable hinge.

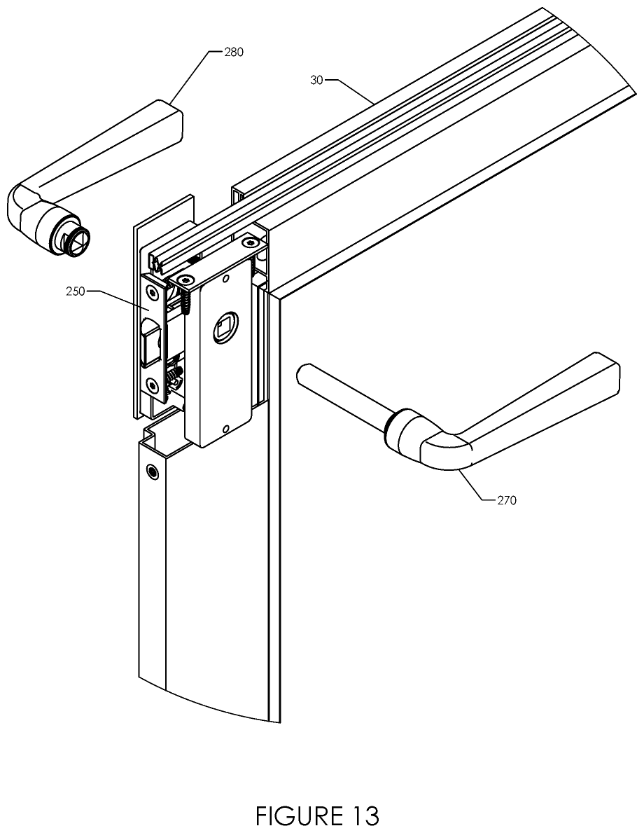

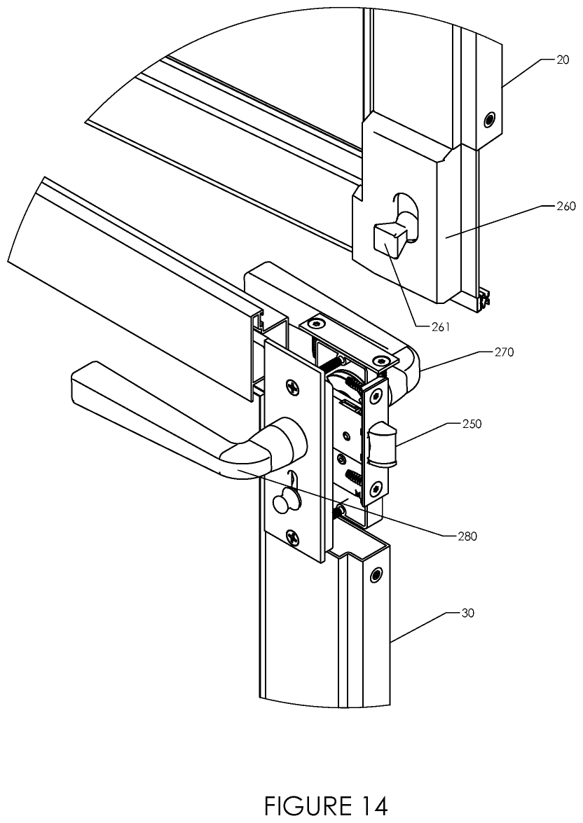

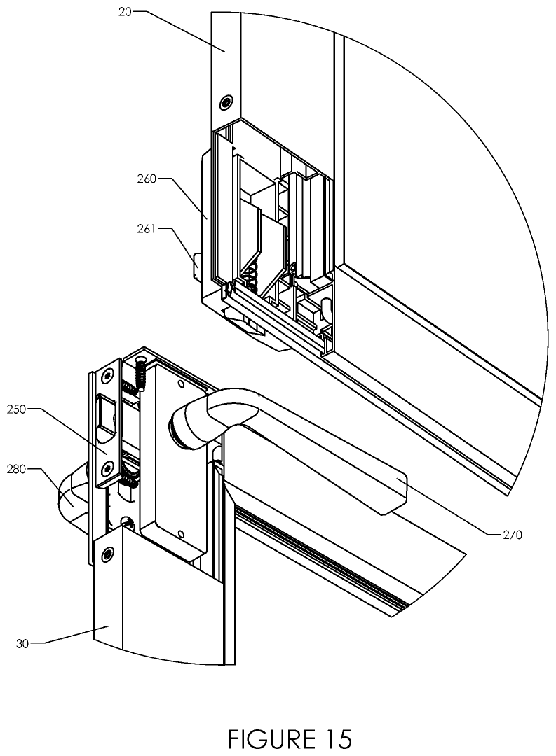

As shown in FIGS. 13-15, lower panel latch assembly 250 is mounted in lower door panel 30. Lower panel latch assembly 250 is operated by use of exterior handle 270 and interior handle 280. Upper panel release assembly 260 is mounted in upper door panel 20. Upper panel release assembly 260 can be engaged by operation of release assembly handle 261 to mechanically couple upper door panel 20 with lower door panel 30 such that they move in tandem, or can be disengaged such that upper door panel 20 can be opened independently of lower door panel 30. In some embodiments, upper door panel 20 can be opened while lower door panel 30 is left closed, but lower door panel 30 cannot be opened farther than upper door panel 20.

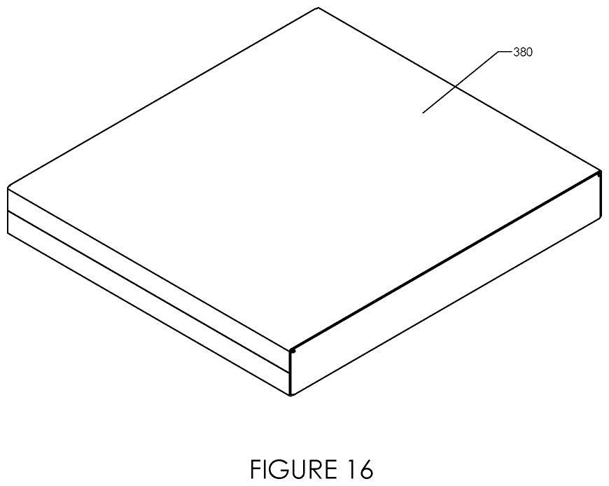

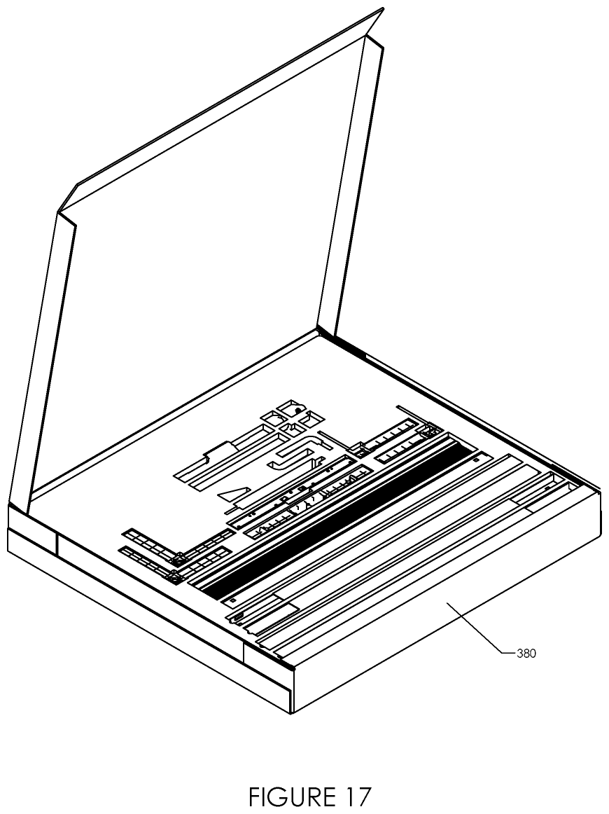

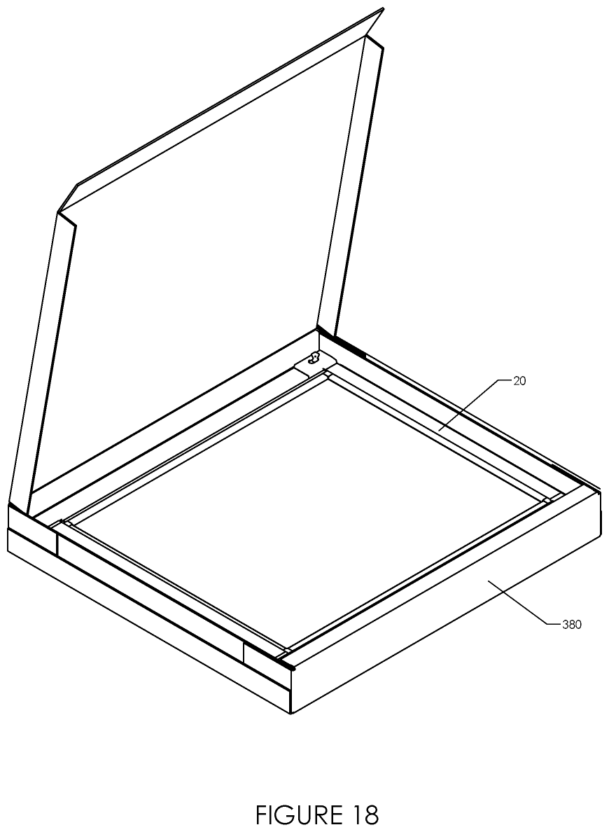

As shown in FIGS. 16-18, the two-piece door kit of the present disclosure may be packaged in carton 380 having a size much smaller and easier to transport than a full sized door. In some embodiments, the total of the carton length plus twice the carton width plus twice the carton thickness is less than or equal to 165 inches. In some embodiments, the carton has no edge longer than 40 inches. Carton 380 may contain parts tray 390 to secure the component parts of the two-piece door kit. Upper door panel 20 and lower door panel 30 may be packed below parts tray 390.

It is recognized that other embodiments of the present may be possible. Other such embodiments include but are not limited to the following:
Upper and lower frame members may be symmetric about their midpoint, creating universal parts that can be used interchangeably in the latch and hinge frame members.
Panels may be installed in such a manner that pivoting of the panels occurs along an axis near either the right side of the door (as illustrated) or the left side of the door, creating a right-hinged or a left-hinged door, respectively. Alternately, the door system may be provided as a right-hinged door or as a left-hinged door.
Frame members, panels, or a combination of the two may carry weatherstripping to enhance the weather-resistance of the door.
Panels may be selected from a wide variety of panel choices:
   Panels of different colors
   Panels constructed from different materials, including steel, aluminum, and plastic
   Panels carrying different types of glass, including clear glass, high efficiency insulated glass, decorative glass, laminated security glass
   Panels carrying screen cloth, security grills, shades or blinds, or pet access doors
   Panels in which the inserts may be permanently affixed in place, or may be removable and exchanged with another insert at different times of the year.

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. A two-piece door kit comprising a latch frame member comprising two or more components that can be connected with one or more connectors, a hinge frame member comprising two or more components that can be connected with one or more connectors, a top frame member that can be connected to the top of the latch frame member and the hinge frame member, a bottom frame member that can be connected to the bottom of the is latch frame member and the hinge frame member, a bottom panel that can be movably attached to the bottom frame member and the hinged frame member, a top panel that can be movably attached to the hinge frame member and the top frame member, and an optional awning that can be attached to the top frame member.

2. The two-piece door kit of claim 1 further comprising a latch to secure the bottom panel, or the top panel or both panels to the latch frame member.

3. The two-piece door kit of claim 1, wherein the bottom and top panels move together or independently.

4. The two-piece door kit of claim 1 further comprising an adjustable connector to secure the bottom and top panels together.

5. The two-piece door kit of claim 1, wherein the bottom and top panels are opaque materials, transparent materials, translucent materials, or screen materials.

6. The two-piece door kit of claim 1, wherein the bottom and top materials are the same or different materials.

7. The two-piece door kit of claim 1, wherein the bottom and top panels move about two or more pins.

8. The two-piece door kit of claim 7, wherein at least one pin is spring-biased to an extended position.

9. The two-piece door kit of claim 1, wherein the awning further comprises one or more accessories including a door light, security camera, alarm system, intercom, automatic door opening and closing mechanism, or a solar cell and battery to collect, store, and provide power to the accessories.

10. The two-piece door kit of claim 1 wherein the two or more latch frame members and hinge frame members snap together with the connectors.

11. The two-piece door kit of claim 1 wherein the two-piece door is a primary door, a storm door, a screen door, or a security door.

12. An assembled two-piece door comprising assembled components of the door kit of claim 1 attached to the exterior face of a door frame.

13. An assembled two-piece door comprising assembled components of the door kit of claim 1 attached within the exterior opening of a door frame.

14. A packaged two-piece door kit of claim 1 comprising a carton in which the total of the carton length plus twice the carton width plus twice the carton thickness is less than or equal to 165 inches.
